(19) United States
(12) Patent Application Publication
(10) Pub. No.: US 2023/0046232 A1
(43) Pub. Date: Feb. 16, 2023

(54) AUTOMATIC DETECTION OF LIDAR TO VEHICLE ALIGNMENT STATE USING CAMERA DATA

(71) Applicant: GM Global Technology Operations LLC, Detroit, MI (US)

(72) Inventors: Xinyu Du, Oakland Township, MI (US); Yao Hu, Sterling Heights, MI (US); Wende Zhang, Birmingham, MI (US); Hao Yu, Troy, MI (US)

(21) Appl. No.: 17/400,529

(22) Filed: Aug. 12, 2021

(51) Int. Cl. G01S 7/497; G01S 17/86; G01S 17/931

(52) U.S. Cl. CPC G01S 7/4972; G01S 17/86; G01S 17/931

(57) ABSTRACT

A system in a vehicle includes a lidar system to obtain lidar data in a lidar coordinate system, a camera to obtain camera data in a camera coordinate system, and processing circuitry to automatically determine an alignment state resulting in a lidar-to-vehicle transformation matrix that projects the lidar data from the lidar coordinate system to a vehicle coordinate system to provide lidar-to-vehicle data. The alignment state is determined using the camera data.

### INTRODUCTION

The subject disclosure relates to automatic detection of lidar to vehicle alignment state using camera data.

Vehicles (e.g., automobiles, trucks, construction equipment, farm equipment) increasingly include sensors that obtain information about the vehicle and its environment. The information facilitates semi-autonomous or autonomous operation of the vehicle. For example, sensors (e.g., camera, radar system, lidar system, inertial measurement unit (IMU), steering angle sensor) may facilitate semi-autonomous maneuvers such as automatic braking, collision avoidance, or adaptive cruise control. Generally, sensors like cameras, radar systems, and lidar systems have a coordinate system that differs from the vehicle coordinate system. The sensor coordinate system must be properly aligned with the vehicle coordinate system to obtain information from the sensor that is easily applicable to vehicle operation. Accordingly, it is desirable to provide automatic detection of lidar to vehicle alignment state using camera data.

### SUMMARY

In one exemplary embodiment, a system in a vehicle includes a lidar system to obtain lidar data in a lidar coordinate system, a camera to obtain camera data in a camera coordinate system, and processing circuitry to automatically determine an alignment state resulting in a lidar-to-vehicle transformation matrix that projects the lidar data from the lidar coordinate system to a vehicle coordinate system to provide lidar-to-vehicle data. The alignment state is determined using the camera data.

In addition to one or more of the features described herein, at least a portion of a field of view of the camera overlaps with a field of view of the lidar system in an overlap region.

In addition to one or more of the features described herein, the processing circuitry uses the lidar-to-vehicle transformation matrix to project the lidar data to the vehicle coordinate system and then uses a vehicle-to-camera transformation matrix to obtain lidar-to-camera data that represents a projection of the lidar data to the camera coordinate system.

In addition to one or more of the features described herein, the processing circuitry extracts lidar feature data from the lidar-to-camera data and extracts camera feature data from the camera data, the lidar feature data and the camera feature data corresponding to edge points.

In addition to one or more of the features described herein, the processing circuitry identifies corresponding pairs from the lidar feature data and the camera feature data, calculates a distance between the lidar feature data and the camera feature data for each of the pairs, and computes an average distance by averaging the distance calculated for each of the pairs.

In addition to one or more of the features described herein, the processing circuitry automatically determines the alignment state based on determining whether the average distance exceeds a threshold value.

In addition to one or more of the features described herein, the processing circuitry identifies objects using the camera data.

In addition to one or more of the features described herein, for each of the objects, the processing circuitry determines a number of points of the lidar-to-camera data that correspond to the object and declares a missed object based on the number of points being below a threshold number of points.

In addition to one or more of the features described herein, the processing circuitry determines a number of the missed objects.

In addition to one or more of the features described herein, the processing circuitry automatically determines the alignment state based on determining whether the number of missed objects exceeds a threshold value.

In another exemplary embodiment, a method includes configuring a lidar system in a vehicle to obtain lidar data in a lidar coordinate system, configuring a camera in the vehicle to obtain camera data in a camera coordinate system, and configuring processing circuitry to automatically determine an alignment state resulting in a lidar-to-vehicle transformation matrix that projects the lidar data from the lidar coordinate system to a vehicle coordinate system to provide lidar-to-vehicle data. The alignment state is determined using the camera data.

In addition to one or more of the features described herein, at least a portion of a field of view of the camera overlaps with a field of view of the lidar system in an overlap region.

In addition to one or more of the features described herein, the method also includes using the lidar-to-vehicle transformation matrix to project the lidar data to the vehicle coordinate system and then using a vehicle-to-camera transformation matrix to obtain lidar-to-camera data that represents a projection of the lidar data to the camera coordinate system.

In addition to one or more of the features described herein, the method also includes extracting lidar feature data from the lidar-to-camera data and to extract camera feature data from the camera data, the lidar feature data and the camera feature data corresponding to edge points.

In addition to one or more of the features described herein, the method also includes identifying corresponding pairs from the lidar feature data and the camera feature data, calculating a distance between the lidar feature data and the camera feature data for each of the pairs, and computing an average distance by averaging the distance calculated for each of the pairs.

In addition to one or more of the features described herein, the method also includes automatically determining the alignment state based on determining whether the average distance exceeds a threshold value.

In addition to one or more of the features described herein, the method also includes identifying objects using the camera data.

In addition to one or more of the features described herein, the method also includes determining, for each of the objects, a number of points of the lidar-to-camera data that correspond to the object and declaring a missed object based on the number of points being below a threshold number of points.

In addition to one or more of the features described herein, the method also includes determining a number of the missed objects.

In addition to one or more of the features described herein, the method also includes automatically determining the alignment state based on determining whether the number of missed objects exceeds a threshold value.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle including automatic detection of lidar to vehicle alignment state;

FIG. 2 is a process flow of a method of performing automatic detection of the alignment state between a lidar coordinate system and a vehicle coordinate system according to an exemplary embodiment; and

FIG. 3 is a process flow of a method of performing automatic detection of the alignment state between a lidar coordinate system and a vehicle coordinate system according to another exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, sensors like the lidar system have a coordinate system that is different than the vehicle coordinate system. Thus, information (e.g., location of objects around the vehicle) from the lidar system must be projected to the vehicle coordinate system through a transformation matrix in order to use the information to control vehicle operation in a straight-forward way. The transformation matrix is essentially a representation of the alignment between the two coordinate systems. That is, the alignment process is the process of finding the transformation matrix. Thus, the transformation matrix correctly projects the lidar information to the vehicle coordinate system when the two coordinate systems are properly aligned, and the transformation matrix does not project the lidar information to the vehicle coordinate system correctly when the two coordinate systems are misaligned. Knowing the alignment state (i.e., aligned or misaligned) is important for correcting the transformation matrix as needed. Further, monitoring the alignment state over time (e.g., dynamically detecting the alignment state) is important because ageing, vibration, an accident, or other factors may change the alignment state.

A prior approach to ensuring alignment between the lidar system and the vehicle involves manually observing lidar point clouds in the lidar coordinate system and those same lidar point clouds projected to the vehicle coordinate system to determine if there is a misalignment in the transformation matrix that is visible in the projected lidar point clouds. This approach has several drawbacks including the time required and the fact that the assessment does not lend itself to being performed in real-time during vehicle operation.

Embodiments of the systems and methods detailed herein relate to automatic detection of lidar to vehicle alignment state (i.e., aligned or misaligned) using camera data. Specifically, lidar data is projected to a camera coordinate system via the lidar to vehicle transformation matrix and a vehicle to camera transformation matrix. Assuming that the vehicle to camera transformation matrix is correct, the lidar to vehicle alignment state may be determined as detailed. For explanatory purposes, lidar data is described as being transformed to the camera coordinate system (based, in part, on the lidar to vehicle transformation matrix). However, alignment state may alternately be verified according to one or more embodiments based on the camera data being transformed to the lidar coordinate system or on the lidar data and the camera data being transformed to the vehicle coordinate system. According to different exemplary embodiments that are detailed, feature data or object identification is used to determine the alignment state.

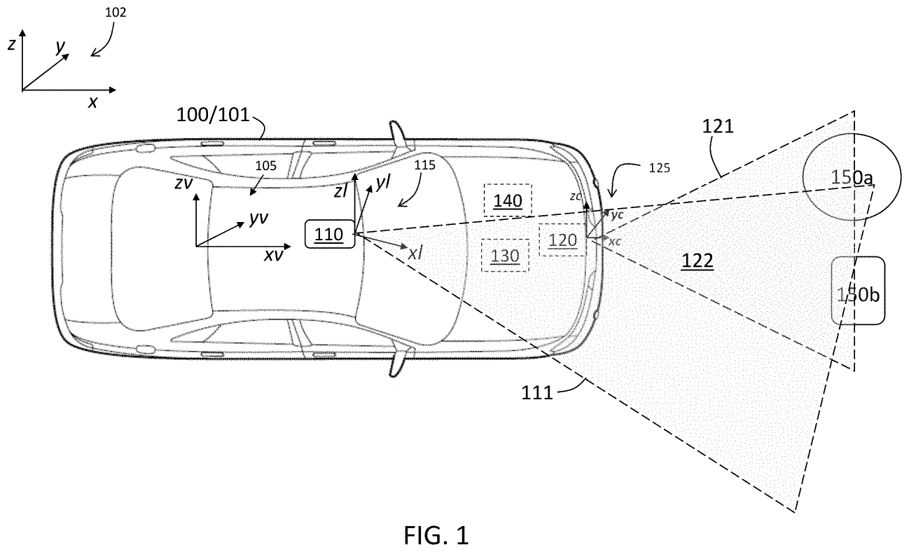

In accordance with an exemplary embodiment, FIG. 1 is a block diagram of a vehicle 100 including automatic detection of lidar to vehicle alignment state using camera data. Detecting the alignment state refers to determining whether the existing transformation matrix projects data from the lidar coordinate system 115 to the vehicle coordinate system 105 correctly (i.e., alignment state is aligned) or not (i.e., alignment state is misaligned). The exemplary vehicle 100 shown in FIG. 1 is an automobile 101. The vehicle is shown to include a lidar system 110 that has the lidar coordinate system 115 and a camera 120 that has a camera coordinate system 125. The world coordinate system 102 is shown in addition to the vehicle coordinate system 105, lidar coordinate system 115, and camera coordinate system 125. The world coordinate system 102 is unchanging while the other coordinate systems 105, 115, 125 may shift with the motion of the vehicle 100. However, this motion does not change the correct transformation matrix (i.e., alignment state) between coordinate systems (e.g., lidar to vehicle coordinate system, vehicle to camera coordinate system) unless the mounted orientation of the lidar system 110 or camera 120 changes.

While one lidar system 110 and one camera 120 are shown, the exemplary illustration is not intended to be limiting with respect to the numbers or locations of sensors. The vehicle 100 may include any number of lidar systems 110, cameras 120, or other sensors 140 (e.g., radar systems, IMU, global navigation satellite system (GNSS) such as global positioning system (GPS)) at any location around the vehicle 100. The other sensors 140 may provide localization information (e.g., location and orientation of the vehicle 100), for example. Further, while two exemplary objects 150a, 150b are shown in FIG. 1, any number of objects 150 may be detected by one or more sensors. The lidar field of view (FOV) 111 and camera FOV 121 are outlined. As indicated, the two fields of view 111, 121 have an overlap region 122. As previously noted, a transformation matrix facilitates the projection of data from one coordinate system to another. As also noted, the process of aligning two coordinate systems is the process of determining the transformation matrix to project data from one coordinate system to the other. A misalignment refers to an error in that transformation matrix.

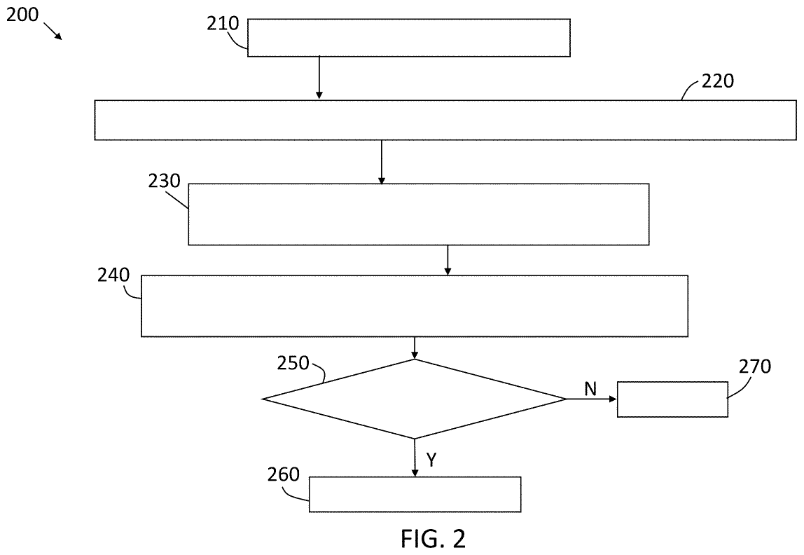

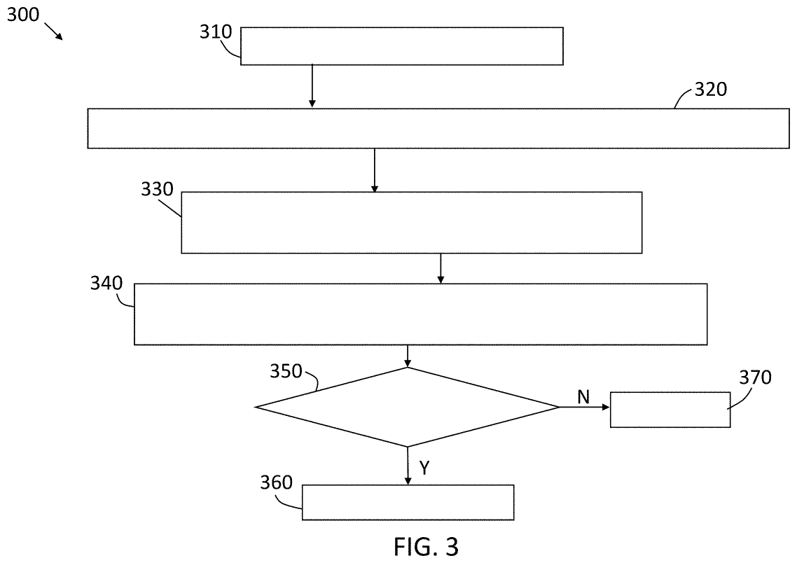

The vehicle 100 includes a controller 130 that controls one or more operations of the vehicle 100. The controller 130 may perform the alignment process between the lidar system 110 and the vehicle 100 (i.e., determine the transformation matrix between the lidar coordinate system 115 and the vehicle coordinate system 105). The controller 130 may additionally implement the processes discussed with reference to FIGS. 2 and 3 to determine an alignment state between the lidar system 110 and the vehicle 100 using camera data. The controller 130 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 is a process flow of a method 200 of performing automatic detection of the alignment state between a lidar coordinate system 115 and a vehicle coordinate system using camera data, according to an exemplary embodiment. The embodiments discussed with reference to FIGS. 2 and 3 rely on the FOV 111 of the lidar system 110 having an overlap (i.e., overlap region 122) with the FOV 121 of the camera 120, as shown in the exemplary scenario of FIG. 1.

At block 210, the processes include obtaining lidar data from the lidar system 110 and obtaining camera data from the camera 120. At block 220, performing a lidar to vehicle transformation then a vehicle to camera transformation involves using two transformation matrices. First, a lidar coordinate system 115 to vehicle coordinate system 105 transformation is performed using an existing lidar to vehicle transformation matrix. The alignment state corresponding to this existing lidar to vehicle transformation matrix is of interest. Next, the result of the lidar to vehicle transformation is further transformed from the vehicle coordinate system 105 to the camera coordinate system 125 using a vehicle to camera transformation matrix.

At block 230, the processes include obtaining lidar feature data from the lidar data in the camera coordinate system 125 (obtained at block 220) and obtaining camera feature data from the camera data (obtained at block 210). Features refer to individually measurable properties or characteristics. According to an exemplary embodiment, the lidar feature data and the camera feature data of interest relates to edge points (e.g., lane markings, road edge, light pole, contour of another vehicle). The feature data may be obtained using known techniques such as principal component analysis (PCA), lidar odometry and mapping (LOAM), or a Canny edge detector. At block 240, pairs are identified between the lidar feature data and the camera feature data. A pair is identified, for example, as a closest lidar feature data point to a given camera feature data point. The distance between the lidar feature data point and the camera feature data point of each pair is determined, and the average distance for all the pairs is computed as part of the processing at block 240.

At block 250, a check is done of whether the average distance is above a threshold. That is, a check is done of whether, on average, the lidar feature data point and the camera feature data point are farther apart than a threshold value. If so, a misalignment is determined as the alignment state, at block 260. To be clear, an indication of misalignment may mean that the lidar to vehicle transformation matrix, the vehicle to camera transformation matrix, or both are erroneous. If, instead, the check at block 250 indicates that, on average, the lidar feature data point and the camera feature data point are not farther apart than a threshold value, then alignment is determined as the alignment state, at block 270. In this case, both the lidar to vehicle transformation matrix and the vehicle to camera transformation matrix are correct.

FIG. 3 is a process flow of a method 300 of performing automatic detection of the alignment state between a lidar coordinate system 115 and a vehicle coordinate system 105 according to another exemplary embodiment. At block 310, like at block 210, the processes include obtaining lidar data in the lidar coordinate system 115 using the lidar system 110 and obtaining camera data in the camera coordinate system 125 using the camera 120. At block 320, like at block 220, performing a lidar to vehicle transformation then a vehicle to camera transformation involves using two transformation matrices. First, a lidar coordinate system 115 to vehicle coordinate system 105 transformation is performed using an existing lidar to vehicle transformation matrix. The alignment state corresponding to this existing lidar to vehicle transformation matrix is of interest. Next, the result of the lidar to vehicle transformation is further transformed from the vehicle coordinate system 105 to the camera coordinate system 125 using a vehicle to camera transformation matrix.

At block 330, identifying one or more objects 150 using the camera data involves using known algorithms to perform image processing. Exemplary object detection techniques involve a you only look once (YOLO) system or a region-based convolutional neural network (R-CNN). At block 340, for each object 150 that is identified using the camera data, a determination is made of the number of lidar points in the camera coordinate system 125 that correspond to the object 150. A correspondence is judged based on a distance between a lidar point in the camera coordinate system 125 and the location of an object detected using the camera data (e.g., the distance is below a predefined threshold). If a threshold number of points from the lidar data in the camera coordinate system 125 do not correspond to a given object that is detected using the camera data, then the object is considered to be missed by the transformed lidar data. In this way, at block 340, a determination is made of the number of the one or more objects 150 detected using the camera data that were missed according to the lidar data in the camera coordinate system 125.

At block 350, a check is done of whether the number of missed objects is greater than a threshold. If the lidar data that is transformed into the camera coordinate system 125 misses more than the threshold number of objects among the one or more objects 150 detected using the camera data, then a misalignment is determined as the alignment state, at block 360. To be clear, an indication of misalignment may mean that the lidar to vehicle transformation matrix, the vehicle to camera transformation matrix, or both are erroneous. If, instead, the check at block 350 indicates that the lidar data in the camera coordinate system 125 did not miss more than the threshold number of objects among the one or more objects 150 detected using the camera data, then alignment is determined as the alignment state, at block 370. In this case, both the lidar to vehicle transformation matrix and the vehicle to camera transformation matrix are correct.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A system in a vehicle comprising:
a lidar system configured to obtain lidar data in a lidar coordinate system;
a camera configured to obtain camera data in a camera coordinate system; and
processing circuitry configured to automatically determine an alignment state resulting in a lidar-to-vehicle transformation matrix that projects the lidar data from the lidar coordinate system to a vehicle coordinate system to provide lidar-to-vehicle data, wherein the alignment state is determined using the camera data.

2. The system according to claim 1, wherein at least a portion of a field of view of the camera overlaps with a field of view of the lidar system in an overlap region.

3. The system according to claim 1, wherein the processing circuitry is configured to use the lidar-to-vehicle transformation matrix to project the lidar data to the vehicle coordinate system and then use a vehicle-to-camera transformation matrix to obtain lidar-to-camera data that represents a projection of the lidar data to the camera coordinate system.

4. The system according to claim 3, wherein the processing circuitry is configured to extract lidar feature data from the lidar-to-camera data and to extract camera feature data from the camera data, the lidar feature data and the camera feature data corresponding to edge points.

5. The system according to claim 4, wherein the processing circuitry is configured to identify corresponding pairs from the lidar feature data and the camera feature data, to calculate a distance between the lidar feature data and the camera feature data for each of the pairs, and to compute an average distance by averaging the distance calculated for each of the pairs.

6. The system according to claim 5, wherein the processing circuitry is configured to automatically determine the alignment state based on determining whether the average distance exceeds a threshold value.

7. The system according to claim 3, wherein the processing circuitry is configured to identify objects using the camera data.

8. The system according to claim 7, wherein, for each of the objects, the processing circuitry is configured to determine a number of points of the lidar-to-camera data that correspond to the object and to declare a missed object based on the number of points being below a threshold number of points.

9. The system according to claim 8, wherein the processing circuitry is configured to determine a number of the missed objects.

10. The system according to claim 9, wherein the processing circuitry is configured to automatically determine the alignment state based on determining whether the number of missed objects exceeds a threshold value.

11. A method comprising:
configuring a lidar system in a vehicle to obtain lidar data in a lidar coordinate system;
configuring a camera in the vehicle to obtain camera data in a camera coordinate system; and
configuring processing circuitry to automatically determine an alignment state resulting in a lidar-to-vehicle transformation matrix that projects the lidar data from the lidar coordinate system to a vehicle coordinate system to provide lidar-to-vehicle data, wherein the alignment state is determined using the camera data.

12. The method according to claim 11, wherein at least a portion of a field of view of the camera overlaps with a field of view of the lidar system in an overlap region.

13. The method according to claim 11, further comprising using the lidar-to-vehicle transformation matrix to project the lidar data to the vehicle coordinate system and then using a vehicle-to-camera transformation matrix to obtain lidar-to-camera data that represents a projection of the lidar data to the camera coordinate system.

14. The method according to claim 13, further comprising extracting lidar feature data from the lidar-to-camera data and to extract camera feature data from the camera data, the lidar feature data and the camera feature data corresponding to edge points.

15. The method according to claim 14, further comprising identifying corresponding pairs from the lidar feature data and the camera feature data, calculating a distance between the lidar feature data and the camera feature data for each of the pairs, and computing an average distance by averaging the distance calculated for each of the pairs.

16. The method according to claim 15, further comprising automatically determining the alignment state based on determining whether the average distance exceeds a threshold value.

17. The method according to claim 13, further comprising identifying objects using the camera data.

18. The method according to claim 17, further comprising determining, for each of the objects, a number of points of the lidar-to-camera data that correspond to the object and declaring a missed object based on the number of points being below a threshold number of points.

19. The method according to claim 18, further comprising determining a number of the missed objects.

20. The method according to claim 19, further comprising automatically determining the alignment state based on determining whether the number of missed objects exceeds a threshold value.
